(19) United States
(12) Patent Application Publication
(10) Pub. No.: US 2022/0397191 A1
(43) Pub. Date: Dec. 15, 2022

(54) FLEXIBLE TRANSMISSION COMPONENT AND METHOD OF MANUFACTURING A TRANSMISSION COMPONENT

(71) Applicant: Schaeffler Technologies AG & Co. KG, Herzogenaurach (DE)

(72) Inventor: Marcel Mergenthaler, Kosbach (DE)

(73) Assignee: Schaeffler Technologies AG & Co. KG, Herzogenaurach (DE)

(21) Appl. No.: 17/777,297

(22) PCT Filed: Sep. 4, 2020
(86) PCT No.: PCT/DE2020/100772

§ 371 Date: May 17, 2022

(30) Foreign Application Priority Data
Nov. 22, 2019 (DE) 10 2019 131 616.2

(51) Int. Cl. F16H 61/00; F16H 49/00; F16H 57/01

(52) U.S. Cl. CPC F16H 61/0006; F16H 49/001; F16H 57/01; F16H 2057/012

(57) ABSTRACT

The invention relates to a flexible transmission components for a harmonic drive comprising a resilient toothing element formed as a sheet metal part and having external toothing, and a printed circuit board bonded to the toothing element.

### CROSS-REFERENCE TO RELATED APPLICATIONS

This application is the U.S. National Phase of PCT Application No. PCT/DE2020/100772 filed on Sep. 4, 2020, which claims priority to DE 10 2019 131 616.2 filed on Nov. 22, 2019, the entire disclosures of which are incorporated by reference herein.

### TECHNICAL FIELD

The disclosure relates to a flexible transmission component which is suitable for use in a harmonic drive. The disclosure further relates to a method for producing such a transmission component.

### BACKGROUND

A harmonic drive is known for example from DE 10 2017 121 024 A1. This harmonic drive has a collar sleeve as a flexible element provided with toothing. The collar of the collar sleeve is firmly connected to a transmission housing which can be rotated as a whole.

DE 10 2010 037 226 B4 describes an actuator which includes a strain shaft transmission, i.e. strain wave gear, and a control and sensor module. In this case, the strain wave gear works with a cup-shaped resilient transmission element.

DE 199 43 021 C2 discloses a flat transmission motor which comprises a pancake motor and a strain wave gearing arranged concentrically thereto.

The combination of a pancake motor with an epicyclic transmission, namely a planetary transmission, is known, for example, from DE 296 22 874 U1. Control electronics are also integrated into the motor-transmission unit thus formed.

WO 2015/007617 A1 discloses a toothed carrier which is intended to accommodate a plurality of toothed segments of a coaxial transmission. The toothed cage is made of plastic using the injection molding process, wherein circuit carriers can be cast into the toothed cage.

### SUMMARY

The object of the disclosure is to provide additional functions of a flexible transmission component for a harmonic drive that go beyond the mechanical function.

According to the disclosure, this object is achieved by a flexible transmission component having the features described herein. The object is also achieved by a method for producing a transmission component also described herein. The configurations and advantages of the disclosure explained below in connection with the production method also apply analogously to the device, i.e. the transmission component, and vice versa.

The flexible transmission component includes a resilient toothing element designed as a sheet metal part, which has external toothing and is also referred to as a transmission component in the narrower sense, and a printed circuit board connected to the toothing element by means of bonding, also generally referred to as a circuit carrier. In typical configurations, the flexibility of the transmission component is provided exclusively or almost exclusively in the area of the toothing element. The printed circuit board, on the other hand, is at most flexible to a comparatively small extent. In particular, the printed circuit board can contribute in the desired manner to the toothing element having a lower elastic resilience in its section bonded to the printed circuit board than in other sections spaced apart from the printed circuit board. Overall, in typical applications, the flexible transmission component is a non-rotating element of a transmission.

The toothing element can be bonded to the printed circuit board either over the entire circumference, that is to say around the entire circumference of the toothing element, or only in individual areas, for example in the form of strips or approximately in the form of points. In an example embodiment, the toothing element is designed as a collar sleeve, wherein the collar of the toothing element is bonded to the printed circuit board. In this case, the external toothing is located on a cylindrical section of the toothing element, wherein the minimum distance between the toothing and the printed circuit board is preferably greater than the thickness of the printed circuit board—to be measured without components soldered on or mounted in any other way.

The transmission component designed as a composite component can generally be produced in the following steps:

Provision of a resilient toothing element, which is formed as a collar sleeve having a cylindrical, externally toothed section and a collar adjoining thereto,

Bonding of a printed circuit board to the collar of the collar sleeve.

The printed circuit board can be bonded to the collar sleeve either while being heated or at room temperature. In the latter case, an acrylate bonding agent is used, for example. If, on the other hand, a thermally curing film is used to produce the connection between the toothing element made of metal, in particular sheet metal, and the printed circuit board, heating to approximately 100° C. takes place, for example. In any case, the bonding connection contributes to a stress equalization between the toothing element and the printed circuit board in the event of thermally induced expansions.

In an example embodiment, there is at least one sensor system that reacts to mechanical stress, that is to say a force sensor system, in particular in the form of a strain gauge, on the collar of the toothing element. Signals supplied by this sensor system can be processed with the aid of evaluation electronics, which are located on the printed circuit board.

A bonding film, which is located between the toothing element and the printed circuit board in the fully assembled transmission component, can be designed as an electrically insulating and yet thermally conductive bonding film. The bonding film, which connects the printed circuit board to the toothing element in the fully assembled transmission component, reduces stresses, in particular, that occur as a result of wobbling movements within the toothing element. Before the printed circuit board and toothing element are assembled, the bonding film can be covered by a protective film.

The transmission component is suitable, for example, for use in a harmonic drive of an electromechanical camshaft adjuster. Likewise, a strain wave gear comprising the transmission component can be used, for example, as an actuating transmission in an articulated arm robot or in a machine tool.

### BRIEF DESCRIPTION OF THE DRAWINGS

In the following, an exemplary embodiment of the disclosure is explained in more detail by means of a drawing. In the figures:

FIG. 1 shows a perspective view of a toothing element for a harmonic drive,

FIGS. 2 and 3 show different views of a printed circuit board to be connected to the toothing element according to FIG. 1,

FIG. 4 shows a transmission component formed from the toothing element and the printed circuit board in a simplified exploded view, and

FIGS. 5 and 6 show a symbolized representation of the assembly steps for the production of the flexible transmission component.

### DETAILED DESCRIPTION

A flexible transmission component identified overall by the reference numeral 1 is designed as a composite component and is intended for use in a harmonic drive, not shown in any more detail. The transmission component 1 is assembled by means of bonding of a toothing element 2 and a printed circuit board 3.

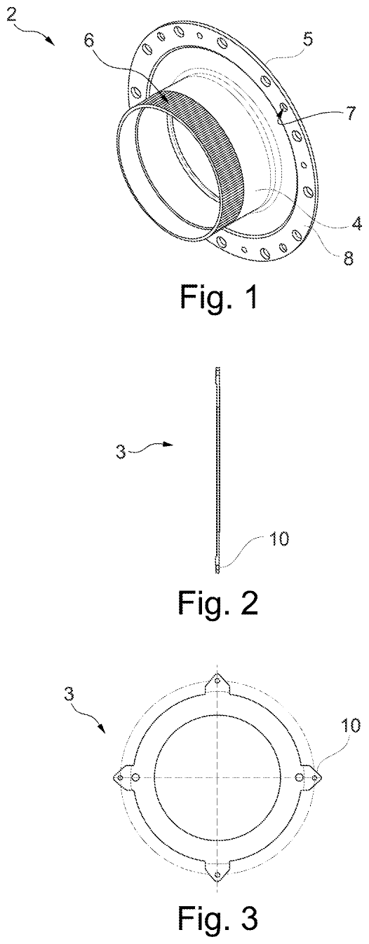

In FIG. 1, the toothing element 2 is shown in an isolated manner. This is a collar sleeve of a known basic shape. The collar sleeve 2 is designed as an integral sheet metal part and describes a cylindrical section 4 and an adjoining collar 5, i.e. a radially outwardly directed flange. The central axis of the cylindrical section 4 coincides with the central axis of the harmonic drive. The cylindrical section 4 has external toothing 6 in an annular section which borders on the end face of the toothing element facing away from the collar 5. The width of the external toothing 6 measured in the axial direction of the toothing element 2 and thus of the entire transmission component 1 is less than half the total width of the cylindrical section 4 measured in the same direction. The toothing element 2 does not rotate within the harmonic drive.

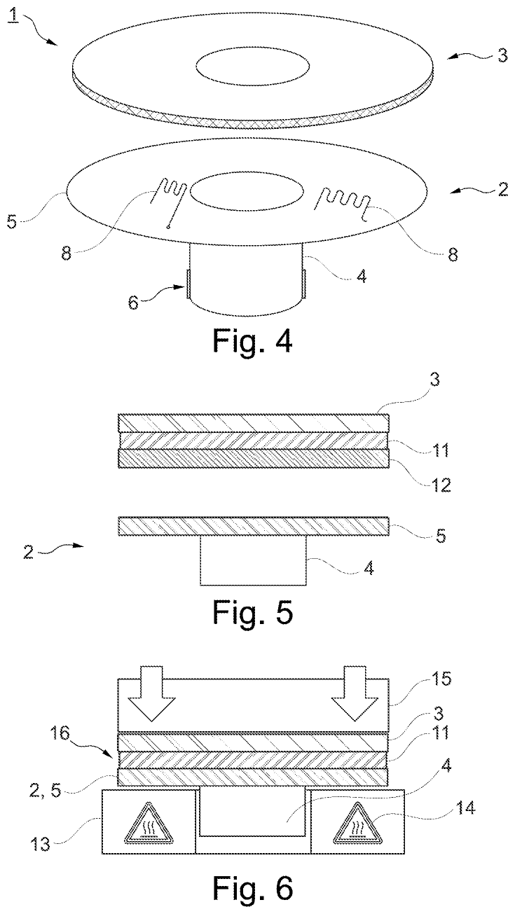

When the harmonic drive is in operation, the cylindrical section 4 is permanently deformed by a wave generator, not shown. The deformations continue into the collar 5 to a lesser extent. The collar 5 has a large number of bores 7 in its outer area. The area of the collar 5 in which the bores 7 are located is referred to as the washer section 8. Virtually no deformations occur within the washer section 8 during operation of the harmonic drive. In areas of the collar 5 that are located further inward, mechanical stresses on the toothing element 2 are detected with the aid of strain gauges 9, which are generally referred to as force sensor systems and are symbolized in FIG. 4.

The signals supplied by the force sensor system 9 are processed further with the aid of an electronic circuit which is arranged on the printed circuit board 3. The printed circuit board 3 shown in isolation in FIGS. 2 and 3 has the shape of a washer with four outwardly directed fastening straps 10 distributed evenly around the circumference.

The production of the flexible transmission component 1 from the toothing element 2 and the printed circuit board 3 is illustrated in FIGS. 5 and 6. On the printed circuit board 3, there is initially a bonding film 11 which is covered by a protective film 12. The toothing element 2 is placed, with the cylindrical section 4 downwards, on a workpiece support 13 which can be heated with the aid of a heating device 14. Use of the heating device 14 depends on the composition of the bonding film 11. On the workpiece resting on the workpiece support 13, i.e. toothing element 2, the printed circuit board 3 is placed under moderate pressure with the aid of a tool 15, which can be moved in the vertical direction, as indicated by two arrows in FIG. 6, wherein a bonding connection 16 between the toothing element 2 and the printed circuit board 3 is produced. Detachment of the bonding connection 16 is not provided. The collar 5 of the collar sleeve 2 is permanently stabilized by the bonding connection 16. At the same time, an economically producible, space-saving, mechanically damping connection is provided between the toothing element 2 and the printed circuit board 3.

### LIST OF REFERENCE SYMBOLS

1 Transmission component
2 Toothing element, collar sleeve
3 Printed circuit board
4 Cylindrical section
5 Collar
6 External toothing
7 Bore
8 Washer section
9 Strain gauges, force sensor system
10 Fastening straps
11 Bonding film
12 Protective film
13 Workpiece support
14 Heating device
15 Tool
16 Bonding connection

1. A flexible transmission component configured for a harmonic drive, the flexible transmission component comprising:
a resilient toothing element formed as a sheet metal part and having external toothing, and
a printed circuit board bonded to the resilient toothing element.

2. (canceled)

3. The flexible transmission component according to claim 1, wherein the resilient toothing element is configured as a collar sleeve having a collar, and the collar is bonded to the printed circuit board.

4. The flexible transmission component according to claim 3, further comprising a force sensor system arranged on the collar of the resilient toothing element.

5. The flexible transmission component according to claim 4, wherein the force sensor system is electrically connected to the printed circuit board.

6. The flexible transmission component according to claim 1, further comprising an electrically insulating and thermally conductive bonding film configured to attach the resilient toothing element to the printed circuit board.

7. A method for producing a transmission component, comprising:
providing a resilient toothing element formed as a collar sleeve having a cylindrical, externally toothed section and a collar adjoining thereto, and
bonding a printed circuit board to the collar of the collar sleeve.

8. The method according to claim 7, wherein the printed circuit board is bonded to the collar sleeve via heating.

9. The method according to claim 7, wherein the printed circuit board is bonded to the collar sleeve at room temperature via an acrylate bonding agent.

10. The flexible transmission component according to claim 1, wherein the flexible transmission component is configured as a non-rotating element in the harmonic drive.

11. The flexible transmission component according to claim 1, wherein the printed circuit board is shaped as a washer.

12. The flexible transmission component according to claim 1, where the printed circuit board is configured with outwardly extending fastening straps.

13. A flexible transmission component configured for a harmonic drive, the flexible transmission component comprising:
a resilient toothing element having:
a cylindrical section,
a collar, and
external toothing, and
a printed circuit board arranged on the collar.

14. The flexible transmission component of claim 13, wherein the collar is integrally formed with the cylindrical section.

15. The flexible transmission component of claim 14, wherein the printed circuit board is bonded to the collar.

16. The flexible transmission component of claim 15, wherein the printed circuit board is bonded to an axial face of the collar.

17. The flexible transmission component of claim 16, wherein the cylindrical section includes external toothing.

18. The flexible transmission component of claim 17, wherein a first width of the external toothing is less than half a second width of the cylindrical section, the first and second widths measured in an axial direction of the resilient toothing element.

19. The flexible transmission component of claim 14, further comprising a force sensor system arranged on the collar of the resilient toothing element.

20. The flexible transmission component of claim 14, further comprising an electrically insulating and thermally conductive bonding film configured to attach the resilient toothing element to the printed circuit board.
